(19) United States
(12) Patent Application Publication
(10) Pub. No.: US 2013/0145026 A1
(43) Pub. Date: Jun. 6, 2013

(54) SIGNAL MANAGER

(71) Applicants: Patrick M. Schoeller, Cypress, TX (US); Sunil Gopalkrishna, The Woodlands, TX (US)

(72) Inventors: Patrick M. Schoeller, Cypress, TX (US); Sunil Gopalkrishna, The Woodlands, TX (US)

(21) Appl. No.: 13/817,842

(22) PCT Filed: Oct. 29, 2010
(86) PCT No.: PCT/US10/54708

§ 371 Date: Feb. 20, 2013

(51) Int. Cl. H04L 29/08

(52) U.S. Cl. 709/224

(57) ABSTRACT

A signal manager includes a signal monitor [102], a programmable logic device [108], a signal storer [116], and a signal router [118]. The signal monitor

is configured for monitoring at least one selected signal of a set of selected signals being captured at a programmable logic device [108]. The selected signal includes at least one signal internal to the programmable logic device [108] that is coupled with a server. The signal storer [116] is configured for storing the monitored set of selected signals. The signal router [118] is configured for routing a portion of the monitored set of selected signals to a selected output location local or remote in response to a routing instruction.

### BACKGROUND

In general, an oscilloscope is a type of electronic test instrument that allows observation and measurement of varying digital signals. In addition to the amplitude of the signal, an oscilloscope can show distortion, the time between two events (such as pulse width, period, or rise time) and relative timing of two related signals.

Frequently, oscilloscopes and logic analyzers are used to troubleshoot malfunctioning electronic equipment. For example, in a piece of electronic equipment, the connections between stages (e.g., electronic mixers, electronic oscillators, amplifiers) may be ‘probed’ for an expected signal, using the oscilloscope as a simple signal tracer. If the expected signal is absent or incorrect, it may be deduced that some preceding stage of the electronics is not operating correctly.

In conjunction with one or more servers, lead wires are soldered for an oscilloscope or otherwise ad hoc coupled onto each server, directly to diverse signal generating points that need to be observed/monitored/measured, and function to observe the electrical signals emitted there from. Thus, when something is suspected to be malfunctioning on a server, one or more lead wires may be ad hoc coupled to one or more of a variety of diverse locations within each server in order to test emitted electrical signals.

### DESCRIPTION OF THE DRAWINGS

FIG. 1A is a block diagram of a signal manager, according to one embodiment of the present technology.

FIG. 1B is a block diagram of a signal manger, according to one embodiment of the present technology.

FIG. 2 is a flow diagram of a method for dynamically routing signals associated with a server to a selected location, according to one embodiment of the present technology.

FIG. 3 is a diagram of an example computer system used for dynamically routing signals associated with a server to a selected location, according to one embodiment of the present technology.

The drawings referred to in this description should not be understood as being drawn to scale unless specifically noted.

### DESCRIPTION OF EMBODIMENTS

Reference will now be made in detail to embodiments of the present technology, examples of which are illustrated in the accompanying drawings. While the technology will be described in conjunction with various embodiment(s), it will be understood that they are not intended to limit the present technology to these embodiments. On the contrary, the present technology is intended to cover alternatives, modifications and equivalents, which may be included within the spirit and scope of the various embodiments as defined by the appended claims.

Furthermore, in the following detailed description, numerous specific details are set forth in order to provide a thorough understanding of the present technology. However, the present technology may be practiced without these specific details. In other instances, well known methods, procedures, components, and circuits have not been described in detail as not to unnecessarily obscure aspects of the present embodiments.

Unless specifically stated otherwise as apparent from the following discussions, it is appreciated that throughout the present detailed description, discussions utilizing terms such as “monitoring”, “storing”, “routing”, “receiving”, “commanding”, “utilizing”, “resetting”, “directing”, or the like, refer to the actions and processes of a computer system, or similar electronic computing device. The computer system or similar electronic computing device manipulates and transforms data represented as physical (electronic) quantities within the computer system's registers and memories into other data similarly represented as physical quantities within the computer system memories or registers or other such information storage, transmission, or display devices. The present technology is also well suited to the use of other computer systems such as, for example, optical computers.

The discussion will begin with a brief overview of a programmable logic device and a complex programmable logic device in relation to the functioning of an oscilloscope and Logic Analyzer. The discussion will then focus on embodiments of the present technology that provide a signal manager for dynamically routing signals associated with a server to a selected location.

### Overview

In general, a programmable logic device (PLD) is an electronic component used to build reconfigurable digital circuits. A PLD has an undefined function at the time of manufacture, and must be programmed (reconfigured) to be used in a circuit. A PLD may be disposed on a portion of a server, wherein the server is a self-contained server. A server is a computer or device on a network that manages network resources. A self-contained server, such as a blade server, has among other things, its own processors, memory, storage, network controllers, operating system and applications. A blade server is a stripped down server with a modular design optimized to minimize the user of physical space and energy. Thus, a different PLD may be disposed on each blade of a plurality of blades within a server housing. The server housing may include rack mounted equipment, a blade enclosure (which holds multiple blades) and/or some other housing that has a server/hardware within it.

An example of a PLD is a programmable array logic (PAL), which is a family of programmable logic device semiconductors used to implement logic functions in digital circuits. Another example of a PLD is a field-programmable gate array (FPGA), which is an integrated circuit designed to be configured by a customer or designer after manufacturing.

Briefly, a complex programmable logic device (CPLD) is a PLD with a complexity between that of the PAL and the FPGA and with architectural features of both. A CPLD has an on-chip non-volatile configuration memory, and can function immediately on system start-up. The CPLD may have thousands to tens of thousands of logic gates, enabling implementation of moderately complicated data processing devices. In most servers, the CPLD performs vital manage and control tasks for the hardware. It has access to many vital signals on the system that perform system management and control.

Currently, in order to determine the source of a problem within a server related to its proper functioning, lead wires are attached to signal probes that are soldered to the server. An oscilloscope/logic analyzer is attached to these signal probes. Thus, adding additional signal probes requires physical modification of the hardware. Monitoring of this hardware and the resulting collection of the data also requires the physical presence of an engineer to operate the oscilloscope or logic analyzer

Further, many times “ad hoc” programming of the PLD is needed to enable monitoring of signals suspected to relate information regarding an electrical problem. A “best guess” is generally used to determine which signals are to be monitored. Thus, selecting and soldering wire leads to be monitored may become an iterative process performed in front of the customer. Of note, the signals that may be monitored are the signals internal (or physically connected to/capable of being routed) to the PLD (or CPLD). There are still signals outside the PLD on the system that will need to be physically probed and cannot be accessed by the PLD.

The current method of observing signals involves at least the following limitations. Firstly, electrical problems may not repeat themselves for the benefit of an oscilloscope or logic analyzer. For example, an unexpected power shut-down may not occur again while the server is attached to an oscilloscope or logic analyzer. Secondly, the density of the server itself makes it difficult and time consuming to attach individual signal probes to each server. Thirdly, these physical modifications may introduce unexpected errors and require additional testing of a new functionality. Fourthly, monitoring PLD signals and states may require the PLD to direct specific signals/states to unused (output) pins, so a technician must be on-site and available for attaching these signal probes to the server.

Thus, the current method requires either custom firmware development for signals to be monitored and/or physically attaching probes to the signals to be monitored. There is no “remote” capability to collect and analyze.

Embodiments of the present technology provide a method enabling real time monitoring of electrical signals and states to be performed from a remote (or local) location. Embodiments alleviate the problem of having to add extraneous signal probes to collect state or transition data for electrical signals already monitored and processed by the PLD. The method according to embodiments of the present technology also provides a mechanism to record data for remote playback of waveforms or fault data. Thus, in one embodiment, the waveform may be viewed through the oscilloscope. In another embodiment, the waveform is captured as data and reproduced (remote or local) to be viewed on a computer display. In essence, a digital storage oscilloscope is created within the PLD.

Thus, embodiments of the present technology provide a method for dynamically routing selected signals associated with a server to a selected local or remote location, thereby alleviating the need for an on-site technician and the time-consuming work of soldering signal probes to individual servers. Further, embodiments of the present technology capture signals in real-time as problems emerge.

For example, a preselected set of signals are sampled at a PLD that is disposed on a server. The signal manager accesses and downloads the signals collected by the PLD, and then stores these signals. Thus, by storing the signals, the PLD also stores state and transition data associated with the server. In one embodiment, the signal manager commands the PLD to route specific signals to an external probing header coupled with the PLD. In another embodiment, the signal manager reports out these stored signals to external users or devices in another embodiment, an external user may retrieve stored signals from the signal manager. In one embodiment, these stored signals are forwarded automatically. In another embodiment, these stored signals may be retrieved from another entity when needed.

The following discussion will begin with a description of the structure of the components of the present technology. The discussion will then be followed by a description of the components in operation.

### Structure

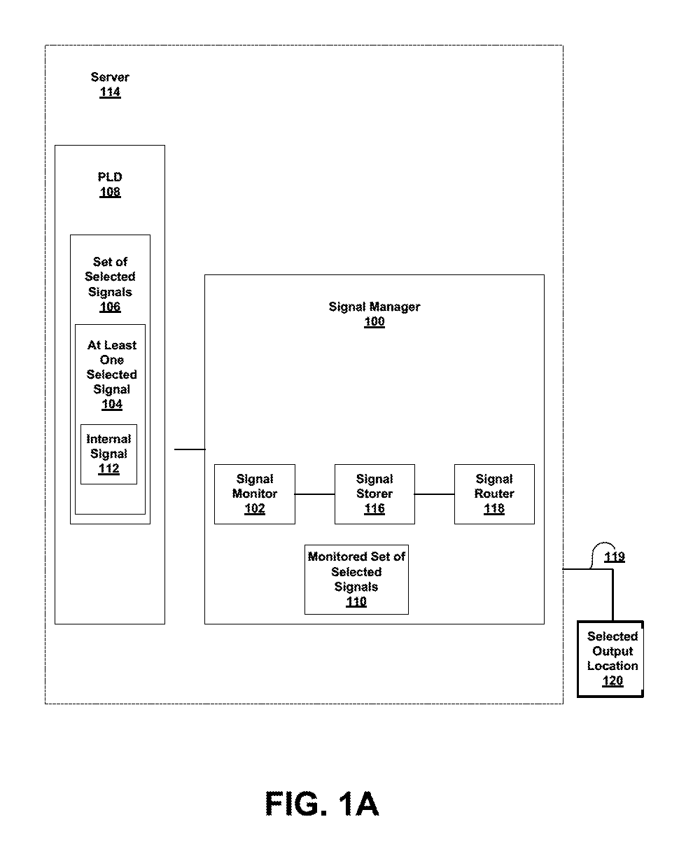

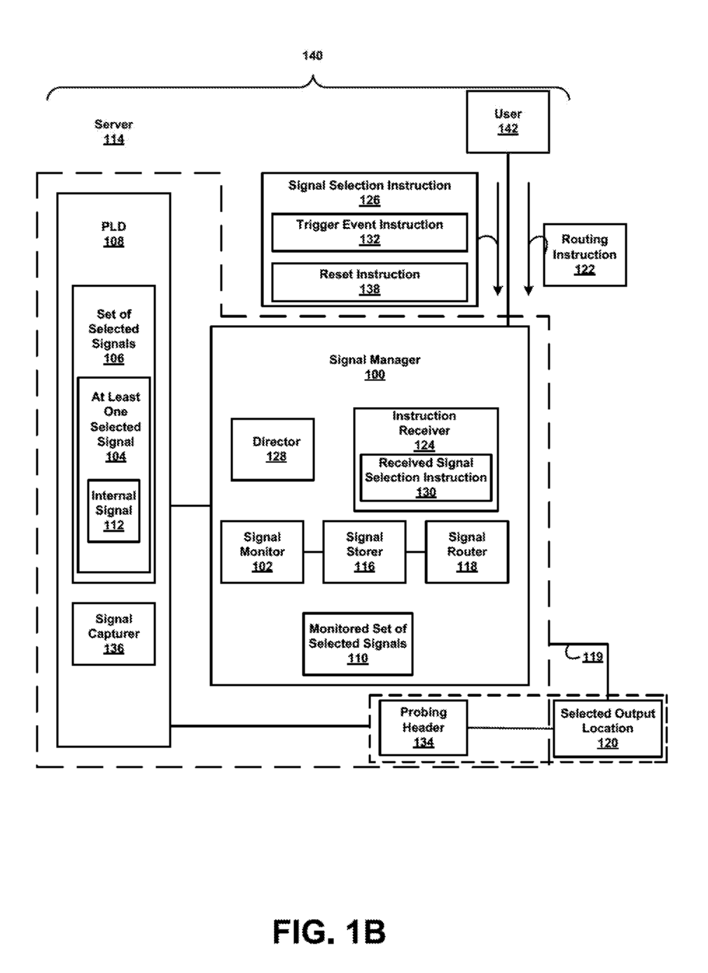

FIG. 1A is a block diagram of a signal manager 100, according to one embodiment of the present technology. FIG. 1B is a block diagram of a signal manager 100, according to another embodiment of the present technology. Referring now to FIGS. 1A and 1B, in one embodiment, the signal manager 100 is disposed on a server 114. In another embodiment, the signal manager 100 is communicatively coupled with, yet remote to the server 114. In embodiments of the present technology, the signal manager 100 includes a signal monitor 102, a signal storer 116 and a signal router 118.

In one embodiment, the signal monitor 102 monitors at least one selected signal 104 of a set of selected signals 106 being captured at a PLD 108 to achieve a monitored set of selected signals 110. The PLD 108 is coupled with the server 114. The at least one selected signal 104 may include at least one internal signal 112 of the PLD 108. An internal signal 112 refers to a signal that is emitted within PLD 108. Thus, the internal signal 112 provides a signal relating to internal functions associated with the PLD 108 functions, such as power rails, system resets, transition data unavailable outside PLD 108, etc. The monitoring of the internal signals 112 provides a description of the state, and therefore transitions occurring on the server 114.

It should be appreciated that while embodiments address a PLD 108, embodiments of the present technology also refer to types of PLDs 108 such as CPLDs and FPGAs

A PLD 108 may be found on every server 114. A user may access the PLD 108, either locally or by remotely communicating with the signal manager 100. Further, in one embodiment, the at least one selected signal 104 may be one of hundreds of signals being monitored, internal and/or external to the PLD 108.

In one embodiment, the signal storer 116 stores the monitored set of selected signals 110. In one embodiment, the monitored set of selected signals 110 is stored in a storage location designated specifically for collecting signals generated by the server 114 and captured by the PLD 108.

In one embodiment, the signal router 118 routes a portion 119 of the monitored set of selected signals 110 to a selected output location 120 in response to a routing instruction 122. It should be appreciated that the portion 119 may be just one signal of the monitored set of selected signals 110, a plurality of signals less than all of the signals of the monitored set of selected signals 110, or all of the signals of the monitored set of selected signals 110. In one embodiment, the routing instruction 122 is received via a programmable interface.

In one embodiment, the selected output location 120 is at a factory or customer field site and is coupled with the server 114. In another embodiment, the selected output location 120 is remote to the server 114. In one embodiment, the probing header 134 is communicatively coupled with the PLD 108. In one embodiment, the probing header 134 is communicatively coupled with and disposed upon the server 114. In one embodiment, the selected output location 120 communicates to a location remote to the server 114.

By way of example, but not of limitation, the selected output location 120 in a factory and/or a customer field site may remotely communicate to a Debug lab set up for problem solving, both locations of which are wired or wirelessly communicatively coupled with the signal manager 100. In an embodiment where the probing header 134 is “fixed” to the server 114, it may receive real time digital signals. In contrast, the “remote” selected output location 120 that is communicatively coupled with the server 114, receives digitized samples of signals.

In one embodiment, signal manager 100 further includes an instruction receiver 124 and a director 128. In one embodiment, the instruction receiver 124 receives a signal selection instruction 126. In one embodiment, the signal selection instruction 126 is predetermined such that it is preprogrammed as part of the signal manager 100 and/or as part of the PLD 108. In another embodiment, an instruction receiver 124 of a signal manager 100 receives a signal selection instruction 126 from a user 142. In one embodiment, the user 142 is an person making a request. In another embodiment, the user 142 is a machine generated instruction (an automated script) (e.g., every morning at two a.m., signals are to be monitored). The signal manager 100 may then relay any received signal selection instruction(s) 130 to the PLD 108. For example, in one embodiment, the director 128 commands the PLD 108 to capture the set of selected signals 106 according to the received signal selection instruction(s) 130.

In one embodiment, the received signal selection instruction 130 is a trigger event instruction 132. A trigger event is an event, the occurrence of which causes (triggers) a capturing of a signal by the PLD 108. For example, a trigger event involves a threshold value being exceeded. The threshold value is digital. For example, if a threshold value is determined to be a particular quantity of error messages, then once the count for that quantity is exceeded, a trigger may be initiated. The “threshold value” may be associated with, but is not limited to, a numerical quantity, a rising edge, a falling edge, and/or a level change of a signal. Thus, in one embodiment, the signal selection instruction 126 includes an instruction such that when a trigger event occurs, such as a threshold value being exceeded, the signal manager 100 accesses the PLD 108 to store a signal or set of signals associated with the exceeded threshold value. In one embodiment, the signal manager 100 already has programmed thereon instructions regarding trigger events.

In another embodiment, the signal selection instruction 126 includes a reset instruction 138. For example, following interruption of a signal capturing process, the reset instruction 138 (when present) may direct resumption of the signal capturing process. A process for capturing signals based on a trigger event occurring may be interrupted and started again, and the resumed process may be based on the same trigger event occurring or on a new trigger event occurring.

In one embodiment, a system 140 for dynamically routing signals associated with a server 114 to a selected location includes: a PLD 108 (as described herein), a server 114, and a signal manager 100 (where both server 114 and signal manager 100 are communicatively coupled with PLD 108).

Thus, embodiments of the present technology provide a unique capability for coupling an oscilloscope or logic analyzer with a server to analyze intermittent failures thereon without the requirement of additional ad hoc soldered signal leads. Moreover, embodiments provide advanced diagnostic capability for complex servers where attaching external signal probes are not physically possible. Furthermore, embodiments provide a defined method to dynamically route designated electrical signals monitored by the PLD without having to reprogram (or FLASH) the physical PLD. Additionally, embodiments allow the monitoring of internal PLD signals and states without having to modify the PLD programming.

### Operation

In embodiments of the present technology during the development and testing process, lead wires no longer need to be soldered ad hoc to a server to examine different signals already available to the PLD. Embodiments enable an engineer to dynamically monitor signals by examining the signals with an external oscilloscope or logic analyzer. By dynamic, it is meant that the monitoring of signals is reconfigurable in a variety of ways. Once configured or reconfigured, the signal manager 100 becomes reactive to conditions or events that occur. In the past, setting up to capture signals may have taken about one or two days due to (among other factors) the often densely packed nature of servers and the frequent requirement for custom programming. However, using techniques described herein, monitoring signals may now be performed in minutes by dynamically routing selected signals to a selected output location.

For example, the server hardware may be designed with a CPLD that will monitor key electrical signals in the platform. The signal manager 100 then dynamically commands the CPLD and retrieves data from the CPLD in real time, using a common command protocol. The common command protocol enables at least the following: dynamically selecting signals to be monitored; dynamically setting the trigger mechanism for each signal; dynamically setting the selected output location 120 for the monitored signal; real time monitoring of the set of selected signals 106; and monitoring of current signal states without resetting the server.

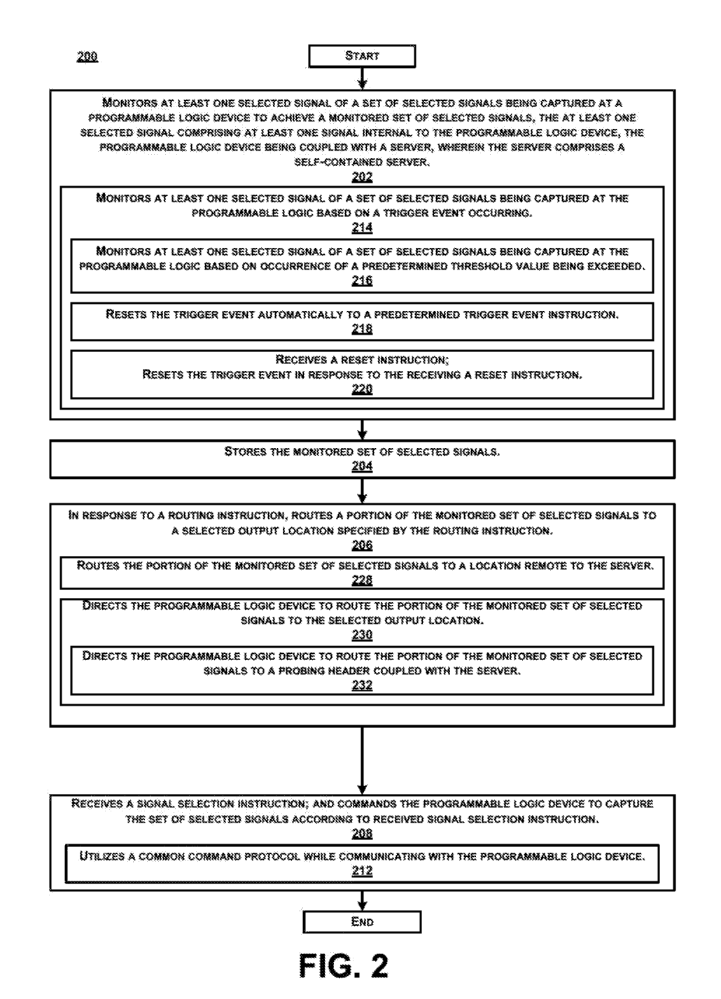

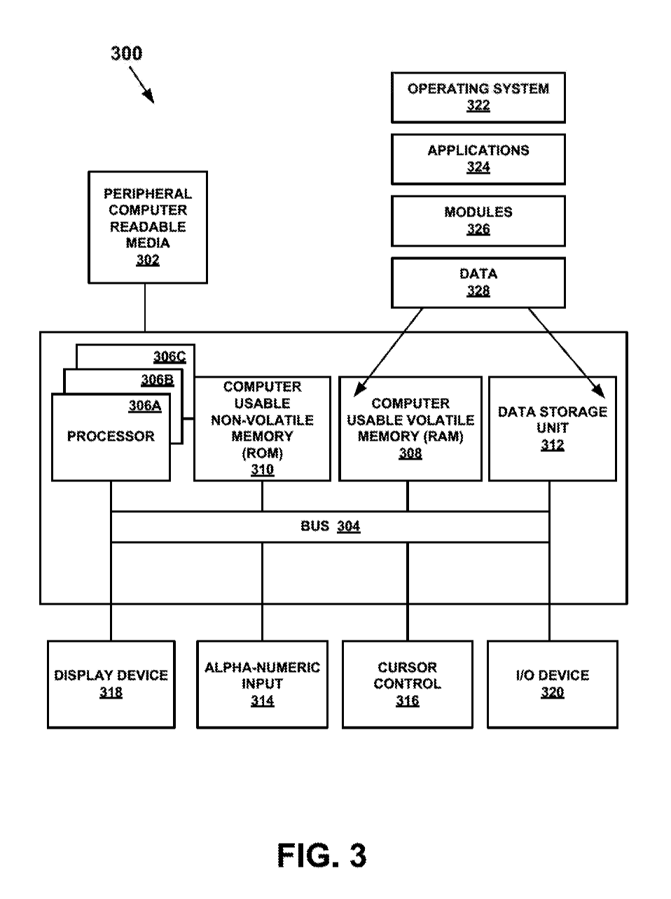

FIG. 2 is a flow diagram of a method 200. In one embodiment, method 200 is embodied in instructions, stored on a non-transitory computer-readable storage medium, which when executed by a computer system (see 300 of FIG. 3), cause the computer system to perform the method 200 for dynamically routing signals associated with a server 114 to a selected location. The method 200 is described below with reference to both FIGS. 1A, 1B and 2.

At 202, in one embodiment and as described herein, the method 200 includes instructions for monitoring the at least one selected signal 104 of a set of selected signals 106 being captured at a PLD 108 thereby achieving a monitored set of selected signals 110. As described herein, in one embodiment, the at least one selected signal 104 includes at least one signal 106 internal to the PLD 108.

In one embodiment and as described herein, at 214, the monitoring 202 is based on a trigger event occurring, such as the accumulation of events. In another embodiment, at 216, the monitoring 202 is based on the occurrence of a predetermined threshold value being exceeded. As described herein, the threshold is digital. The digital threshold value is fixed and is not in the PLD 108 itself. In yet another embodiment, the monitoring 202 occurs in real time. In one embodiment, of the monitoring 202, the at least one selected signal 104 includes at least one signal external to the PLD 108. It should be noted that, in one embodiment, while the monitoring 202 occurs in real time, the review of the monitored set of selected signals 110 occurs some time after the storing of the monitored set of selected signals 110 occurs. The review may occur immediately after the storing of the monitored set of selected signals 110, days later, or sometime there between.

At 204, in one embodiment, the method 200 includes instructions for storing the monitored set of selected signals 110. As described herein, the set of selected signals 106 are captured by PLD 108. Based on the received signal selection instruction 130, the signal storer 116 stores at least one selected signal 104 or a plurality of the selected signals of the set of selected signals 106. For example, the instruction receiver 124 may receive a signal selection instruction 126 that directs the signal monitor 102 to just access the portion of the set of selected signals 106 that relates to a particular threshold value being exceeded.

At 206, in one embodiment, the method 200 includes instructions for routing a portion 119 of the monitored set of selected signals 110 to a selected output location 120 specified by and in response to the routing instruction 122. In one embodiment, at 228, a portion of the monitored set of selected signals 110 is routed to a location remote to the server 114. It should be noted that portion 119 may be just one selected signal of the monitored set of selected signals 110 or a plurality of selected signals. The portion 119 may also entail all of the monitored set of selected signals 110.

Further, at 230, in one embodiment, the PLD 108 is directed to route the portion of the monitored set of selected signals 119 to the selected output location 120. At 232, in another embodiment, the PLD 108 is directed to route the portion of the monitored set of selected signals 119 to a probing header 134 coupled with the server 114. In yet another embodiment, at 234, the PLD 108 is directed to route the portion of the monitored set of selected signals 119 to a location remote to the server 114.

At 208, in one embodiment, the method 200 receives a signal selection instruction 126. Further, in another embodiment, at 208, the method 200 commands the PLD 108 to capture the set of selected signals 106 according to the received signal selection instruction 130. In yet another embodiment, at 212, a common command protocol is utilized while communicating with the PLD 108.

In one embodiment and as described herein, at 218, the method 200 resets the trigger event automatically according to a trigger event instruction 132. In one embodiment, the signal manager 100 already includes a trigger event instruction 132, the trigger event instruction 132 being “predetermined”. While in another embodiment, the trigger event instruction 132 is provided by a user 142. In another embodiment and as described herein, at 220 the method 200 receives a reset instruction 138. In one embodiment and as described herein, the method 200 at 220 includes an instruction for resetting a trigger event in response to receiving the reset instruction 138.

### Example Computer System Environment

With reference now to FIG. 3, portions of the technology for dynamically routing signals associated with a server to a selected location are composed of computer-readable and computer-executable instructions that reside, for example, in computer-readable storage media of a computer system. That is, FIG. 3 illustrates one example of a type of computer that can be used to implement embodiments, which are discussed below, of the present technology.

FIG. 3 illustrates an example computer system 300 used in accordance with embodiments of the present technology. It is appreciated that system 300 of FIG. 3 is an example only and that the present technology can operate on or within a number of different computer systems including general purpose networked computer systems, embedded computer systems, routers, switches, server devices, user devices, various intermediate devices/artifacts, stand alone computer systems, and the like. As shown in FIG. 3, computer system 300 of FIG. 3 is well adapted to having peripheral computer readable media 302 such as, for example, a floppy disk, a compact disc, and the like coupled thereto.

System 300 of FIG. 3 includes an address/data bus 304 for communicating information, and a processor 306A coupled to bus 304 for processing information and instructions. As depicted in FIG. 3, system 300 is also well suited to a multi-processor environment in which a plurality of processors 306A, 306B, and 306C are present. Conversely, system 300 is also well suited to having a single processor such as, for example, processor 306A. Processors 306A, 306B, and 306C may be any of various types of microprocessors. System 300 also includes data storage features such as a computer usable volatile memory 308, e.g. random access memory (RAM), coupled to bus 304 for storing information and instructions for processors 306A, 306B, and 3060.

System 300 also includes computer usable non-volatile memory 310, e.g. read only memory (ROM), coupled to bus 304 for storing static information and instructions for processors 306A, 306B, and 306C. Also present in system 300 is a data storage unit 312 (e.g., a magnetic or optical disk and disk drive) coupled to bus 304 for storing information and instructions. System 300 also includes an optional alphanumeric input device 314 including alphanumeric and function keys coupled to bus 304 for communicating information and command selections to processor 306A or processors 306A, 306B, and 3060. System 300 also includes an optional cursor control device 316 coupled to bus 304 for communicating user input information and command selections to processor 306A or processors 306A, 306B, and 3060. System 300 of the present embodiment also includes an optional display device 318 coupled to bus 304 for displaying information.

Referring still to FIG. 3, optional display device 318 of FIG. 3 may be a liquid crystal device, cathode ray tube, plasma display device or other display device suitable for creating graphic images and alphanumeric characters recognizable to a user. Optional cursor control device 316 allows the computer user to dynamically signal the movement of a visible symbol (cursor) on a display screen of display device 318. Many implementations of cursor control device 316 are known in the art including a trackball, mouse, touch pad, joystick or special keys on alpha-numeric input device 314 capable of signaling movement of a given direction or manner of displacement. Alternatively, it will be appreciated that a cursor can be directed and/or activated via input from alpha-numeric input device 314 using special keys and key sequence commands.

System 300 is also well suited to having a cursor directed by other means such as, for example, voice commands. System 300 also includes an I/O device 320 for coupling system 300 with external entities. For example, in one embodiment I/O device 320 is a modem for enabling wired or wireless communications between system 300 and an external network such as but not limited to the Internet. A more detailed discussion of the present technology is found below.

Referring still to FIG. 3, various other components are depicted for system 300. Specifically, when present, an operating system 322, applications 324, modules 326, and data 328 are shown as typically residing in one or some combination of computer usable volatile memory 308, e.g. random access memory (RAM), and data storage unit 312. However, it is appreciated that in some embodiments, operating system 322 may be stored in other locations such as on a network or on a flash drive; and that further, operating system 322 may be accessed from a remote location via, for example, a coupling to the internet. In one embodiment, the present technology, for example, is stored as an application 324 or module 326 in memory locations within RAM 308 and memory areas within data storage unit 312. The present technology may be applied to one or more elements of described system 300. For example, a method for identifying a device associated with a transfer of content may be applied to operating system 322, applications 324, modules 326, and/or data 328.

The computing system 300 is only one example of a suitable computing environment and is not intended to suggest any limitation as to the scope of use or functionality of the present technology. Neither should the computing environment 300 be interpreted as having any dependency or requirement relating to any one or combination of components illustrated in the example computing system 300.

The present technology may be described in the general context, of computer-executable instructions, such as program modules, being executed by a computer. Generally, program modules include routines, programs, objects, components, data structures, etc., that perform particular tasks or implement particular abstract data types. The present technology may also be practiced in distributed computing environments where tasks are performed by remote processing devices that are linked through a communications network. In a distributed computing environment, program modules may be located in both local and remote computer-storage media including memory-storage devices.

The present technology may be described in the general context of computer-executable instructions, such as program modules, being executed by a computer. Generally, program modules include routines, programs, objects, components, data structures, etc., that perform particular tasks or implement particular abstract data types. The present technology may also be practiced in distributed computing environments where tasks are performed by remote processing devices that are linked through a communications network. In a distributed computing environment, program modules may be located in both local and remote computer-storage media including memory-storage devices.

All statements herein reciting principles, aspects, and embodiments of the invention as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. The scope of the present invention, therefore, is not intended to be limited to the exemplary embodiments shown and described herein. Rather, the scope and spirit of present invention is embodied by the appended claims.

What is claimed is:

1. A non-transitory computer-readable storage medium comprising instructions stored thereon which, when executed by a computer system cause the computer system to perform a method [200] for dynamically routing signals associated with a server to a selected location, said method [200] comprising instructions for:
monitoring [202] at least one selected signal [102] of a set of selected signals [106] being captured at a programmable logic device [108] to achieve a monitored set of selected signals [110], said at least one selected signal [104] comprising at least one signal internal to said programmable logic device [108], said programmable logic device [108] being coupled with said server [114], wherein said server [114] comprises a self-contained server:
storing [204] said monitored set of selected signals [110]; and in response to a routing instruction [122], routing [228] a portion of said monitored set of selected signals [110] to a selected output location [120] specified by said routing instruction [122].

2. The non-transitory computer-readable storage medium of claim 1, wherein said method [200] further comprises instructions for:
receiving [208] a signal selection instruction [126]; and
commanding said programmable logic device [108] to capture said set of selected signals according to received signal selection instruction [126].

3. The non-transitory computer-readable storage medium of claim 2, wherein said commanding said programmable logic device [108] to measure a selected signal comprises:
utilizing [212] a common command protocol while communicating with said programmable logic device [108].

4. The non-transitory computer-readable storage medium of claim 2, wherein said monitoring at least one selected signal [104] of a set of selected signals [106] being captured at a programmable logic device [108] comprises:
monitoring [214] at least one selected signal of a set of selected signals being captured at said programmable logic device [108] based on a tugger event occurring.

5. The non-transitory computer-readable storage medium of claim 4, wherein said monitoring at least one selected signal of a set of selected signals being captured at said programmable logic device [108] based on a trigger event occurring comprises:
monitoring at least one selected signal [104] of a set of selected signals [106] being captured at said programmable logic device [108] based on an occurrence of a trigger selected from a group of huggers consisting of a rising edge, a falling edge, a change in rate or a threshold value being exceeded.

6. The non-transitory computer-readable storage medium of claim 4, wherein said method [200] further comprises instructions for resetting said trigger event automatically according to a predetermined trigger event instruction [132].

7. The non-transitory computer-readable storage medium of claim 6, wherein said method [132] further comprises instructions for:
receiving [220] a reset instruction [138]; and
resetting said trigger event in response to said receiving a reset instruction [138].

8. A non-transitory computer-readable storage medium of claim 1, wherein said monitoring at least one selected signal [104] of a set of selected signals [106] being captured at a programmable logic device [108]comprises:
monitoring in real-time at least one selected signal [104] of a set of selected signals [104] being captured at a programmable logic device [108] to achieve a monitored set of selected signals [110], said at least one selected signal [104] comprising at least one signal internal to said programmable logic device [108], said programmable logic device [108] being coupled with said server [114]. Wherein said server [114] comprises a self-contained server:
storing [204] said monitored set of selected signals [110]; and
in response to a routing instruction [122], routing [228] a portion of said monitored set of selected signals [110] to a selected output location [120] specified by said routing instruction [122].

9. The non-transitory computer-readable storage medium of claim 1, wherein said monitoring at least one selected signal [104] of a set of selected signals [106] being captured at a programmable logic device [108] to achieve a monitored set of selected signals [110] comprises:
monitoring at least one selected signal [104] of a set of selected signals [106] being captured at a programmable logic device [108] to achieve a monitored set of selected signals [1101 wherein said at least one selected signal [104] comprises at least one signal external to said programmable logic device [108].

10. The non-transitory computer-readable storage medium of claim 1, wherein said routing a portion of said monitored set of selected signals to a selected output location specified by said routing instruction comprises:
routing [228] said portion of said monitored set of selected signals [110] to a location remote to said server [114].

11. The non-transitory computer-readable storage medium of claim 1, wherein said routing [228] a portion of said monitored set of selected signals to a selected output location [120] specified by said routing instruction comprises:
directing [230] said programmable logic, device [108] to route said portion of said monitored set of selected signals [110] to said selected output location [120].

12. The non-transitory computer-readable storage medium of claim 1, wherein said directing [230] said programmable logic device [108] to route said portion of said monitored set of selected signals [110] to said selected output location comprises:
directing [232] said programmable logic device [108] to route said portion of said monitored set of selected signals [110] to a probing header [1 34] coupled with said server [114].

13. A signal manager [100], said signal manager [100] comprising:
a signal monitor [102] configured for monitoring at least one selected signal [104] of a set of selected signals [106] being captured at a programmable logic device [108] to achieve a monitored set of selected signals [110], said at least one selected signal [104] comprising at least one signal internal to said programmable logic device [108], said programmable logic device [108] being coupled with a server [114], wherein said server [114] comprises a self-contained server:
a signal storer [116] configured for storing said monitored set of selected signals [110]; and
a signal router [118] configured for routing a portion of said monitored set of selected signals to a selected output location [120] in response to a routing instruction [122].

14. The signal manager [100] of claim 13, fluffier comprising:
an instruction receiver [124] configured for receiving a signal selection instruction 126]; and
a director [128] configured for commanding said programmable logic device [108] to capture said set of selected signals [106] according to received signal selection instruction [130].

15. The signal manager [100] of claim 14, wherein said received signal selection instruction [130] comprises a trigger reset instruction [138].
